(19) United States
(12) Patent Application Publication
(10) Pub. No.: US 2018/0189266 A1
(43) Pub. Date: Jul. 5, 2018

(54) METHOD AND A SYSTEM TO SUMMARIZE A CONVERSATION

(71) Applicant: Wipro Limited, Bangalore (IN)

(72) Inventors: Arthi Venkataraman, Bangalore (IN); Ajay Anantha, Bangalore (IN)

(21) Appl. No.: 15/433,687

(22) Filed: Feb. 15, 2017

(30) Foreign Application Priority Data
Jan. 3, 2017 (IN) 201741000251

(51) Int. Cl. G06F 17/27; G06F 17/24

(52) U.S. Cl. CPC G06F 17/279; H04L 67/42; G06F 17/24; G06F 17/2775

(57) ABSTRACT

A method and a system are described for summarizing a conversation. The method includes splitting a plurality of sentences in the conversation into one or more phrases based on pre-defined grammar rules. The method includes extracting one or more relevant phrases associated with each of the one or more phrases based on domain dictionaries and pre-defined knowledge base. The method includes determining a correlation between each of the one or more phrases and the one or more relevant phrases based on a relationship score. The method includes identifying at least one of a core topic of discussion in the conversation, one or more issues, one or more resolved issues, and one or more unresolved issues based on the correlation.

The method includes creating a summary of the conversation based on the core topic of discussion, one or more issues, one or more resolved issues, and one or more unresolved issues.

This application claims the benefit of Indian Patent Application Serial No. 201741000251, filed Jan. 3, 2017, which is hereby incorporated by reference in its entirety.

### TECHNICAL FIELD

The present subject matter is related, in general to electrical data processing and more specifically, but not exclusively to a method and a system for summarization of a conversation

### BACKGROUND

In a conversation, there may be a plurality of topics that may be discussed. There may be a requirement to keep a record of the conversations for future reference. If one may record the entire conversation, be it in textual format or audio format, it shall require, at any later point of time, a user to go through the entire conversation, to understand the content, topic and issue in the conversation. This is time consuming and not feasible in a situation where a spontaneous decision must be taken.

Furthermore, when an end user calls a virtual agent for solutions and the virtual agent is unable to do so, then the user may escalate the matter to a higher authority/manual agent for resolving the problem. The higher authority/manual agent may have to converse again with the end user to identify the problem. Existing conversation summarization systems fail to identify the core topic of discussion in the conversation, one or more issues in the conversation, one or more resolved issues and one or more unresolved issues.

The limitations and disadvantages of conventional and traditional approaches may become apparent to one skilled in the art, through comparison of systems described with some aspects of the present disclosure, as set forth in the remainder of the present application and with reference to the drawings.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

According to embodiments illustrated herein, there may be provided a method for summarizing a conversation. The method may include splitting each of a plurality of sentences in the conversation into one or more phrases based on one or more pre-defined grammar rules. In an embodiment, the one or more phrases may be utilized to update a pre-defined knowledge base. The method may include extracting one or more relevant phrases associated with each of the one or more phrases based on domain dictionaries and the pre-defined knowledge base. The method may include determining a correlation between each of the one or more phrases and the one or more relevant phrases based on a relationship score. The method may include identifying at least one of a core topic of discussion in the conversation, one or more issues associated with the core topic of discussion, one or more resolved issues from the one or more issues, and one or more unresolved issues from the one or more issues based on the determined correlation. The method may include creating a summary of the conversation based on the identified core topic of discussion in the conversation, the one or more issues, the one or more resolved issues, and the one or more unresolved issues.

According to embodiments illustrated herein, there may be provided a summary creation server to summarize a conversation, which includes a processor; and a memory communicatively coupled to the processor, wherein the memory stores processor instructions, which, on execution, causes the processor to, split each of a plurality of sentences in the conversation into one or more phrases based on one or more pre-defined grammar rules. In an embodiment, the one or more phrases may be utilized to build a pre-defined knowledge base. The processor may be further configured to extract one or more relevant phrases associated with each of the one or more phrases based on domain dictionaries and the pre-defined knowledge base. The processor may be configured to determine a correlation between each of the one or more phrases and the one or more relevant phrases based on a relationship score. The processor may be configured to identify at least one of a core topic of discussion in the conversation, one or more issues associated with the core topic of discussion, one or more resolved issues from the one or more issues, and one or more unresolved issues from the one or more issues based on the correlation. The processor may be configured to create a summary of the conversation based on the identified core topic of discussion in the conversation, the one or more issues, the one or more resolved issues, and the one or more unresolved issues.

According to embodiments illustrated herein, a non-transitory computer-readable storage medium having stored thereon, a set of computer-executable instructions for causing a computer comprising one or more processors to perform steps comprising, splitting each of a plurality of sentences in a conversation into one or more phrases based on one or more pre-defined grammar rules. In an embodiment, the one or more key phrases are utilized to build a pre-defined knowledge base. The one or more processors may be configured to extract one or more relevant phrases associated with each of the one or more phrases based on domain dictionaries and the pre-defined knowledge base. The one or more processors may be configured to determine a correlation between each of the one or more phrases and the one or more relevant phrases based on a relationship score. The one or more processors may be configured to identify at least one of a core topic of discussion in the conversation, one or more issues associated with the core topic of discussion, one or more resolved issues from the one or more issues, and one or more unresolved issues from the one or more issues based on the determined correlation. The one or more processors may be configured to create a summary of the conversation based on the identified core topic of discussion in the conversation, the one or more issues, the one or more resolved issues, and the one or more unresolved issues.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 is a block diagram that illustrates a system environment in which various embodiments of the method and the system may be implemented;

FIG. 2 is a block diagram that illustrates a summary creation server configured to summarize a conversation, in accordance with some embodiments of the present disclosure;

FIG. 3 is a flowchart illustrating a method for summarizing a conversation, in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

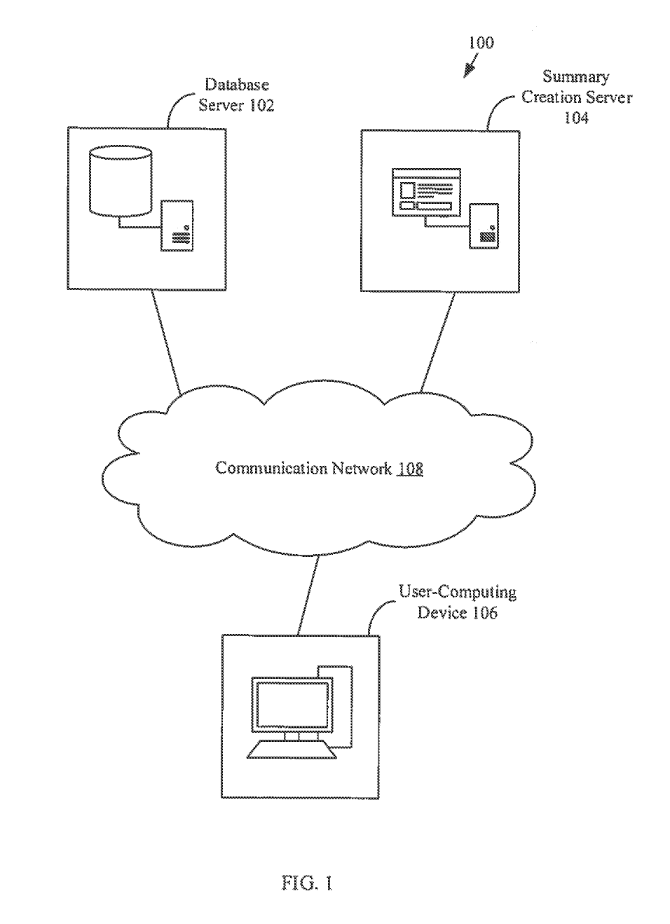

FIG. 1 is a block diagram that illustrates a system environment 100 in which various embodiments of the method and the system may be implemented. The system environment 100 may include a database server 102, a summary creation server 104, a user-computing device 106, and a communication network 108. The summary creation server 104 may be communicatively coupled to the database server 102 and the user-computing device 106 via the communication network 108. In an embodiment, the summary creation server 104 may communicate with the database server 102 using one or more protocols such as, but not limited to, Open Database Connectivity (ODBC) protocol and Java Database Connectivity (JDBC) protocol. In an embodiment, the user-computing device 106 may communicate with the summary creation server 104, via the communication network 106.

In an embodiment, the database server 102 may refer to a computing device that may be configured to store one or more pre-defined grammar rules, a pre-defined knowledge base and domain dictionaries. In an embodiment, the database server 102 may include a special purpose operating system specifically configured to perform one or more predetermined database operations. Examples of database operations may include, but are not limited to, Select, Insert, Update, and Delete. In an embodiment, the database server 102 may include hardware and/or software that may be configured to perform one or more predetermined operations. In an embodiment, the database server 102 may be realized through various technologies such as, but not limited to, Microsoft® SQL Server, Oracle®, IBM DB2®, Microsoft Access®, PostgreSQL®, MySQL® and SQLite®, and the like.

In an embodiment, the database server 102 may be configured to receive a request from the user-computing device 106 to obtain domain dictionaries. The database server 102 may be configured to update the one or more pre-defined grammar rules based on the learning information received from the summary creation server 104. A person with ordinary skills in the art will understand that the scope of the disclosure is not limited to the database server 102 as a separate entity. In an embodiment, the functionalities of the database server 102 can be integrated into the summary creation server 104, and vice versa.

In an embodiment, the summary creation server 104 may refer to a computing device or a software framework hosting an application or a software service. In an embodiment, the summary creation server 104 may be implemented to execute procedures such as, but not limited to, programs, routines, or scripts stored in one or more memories for supporting the hosted application or the software service. In an embodiment, the hosted application or the software service may be configured to perform one or more predetermined operations. The summary creation server 104 may be realized through various types of servers such as, but are not limited to, a Java application server, a .NET framework application server, a Base4 application server, a PHP framework application server, or any other application server framework.

In an embodiment, the summary creation server 104 may be configured to split each of a plurality of sentences in the conversation into one or more phrases based on one or more pre-defined grammar rules. In an embodiment, the one or more phrases may be utilized to update a pre-defined knowledge base. In an embodiment, the summary creation server 104 may be configured to extract one or more relevant phrases associated with each of the one or more phrases based on domain dictionaries and the pre-defined knowledge base. In an embodiment, the summary creation server 104 may be configured to determine a correlation between each of the one or more phrases and the one or more relevant phrases based on a relationship score. In an embodiment, the summary creation server 104 may be configured to identify at least one of a core topic of discussion in the conversation, one or more issues associated with the core topic of discussion, one or more resolved issues from the one or more issues, and one or more unresolved issues from the one or more issues based on the determined correlation. In an embodiment, the summary creation server 104 may be configured to create a summary of the conversation based on the identified core topic of the discussion in the conversation, the one or more issues, the one or more resolved issues, and the one or more unresolved issues.

In an embodiment, the user-computing device 106 may refer to a computing device used by a user. The user-computing device 106 may include one or more processors and one or more memories. The one or more memories may include computer readable code that may be executable by the one or more processors to perform predetermined operations. In an embodiment, the user-computing device 106 may present a user-interface to the user to transmit a request for summarization of the conversation. In an embodiment, the user-computing device 106 may be configured to receive the summary created by the summary creation server 104. The user computing device 106 may display to the user, the summary created by the summary creation server 104. Examples of the user-computing device 106 may include, but are not limited to, a personal computer, a laptop, a personal digital assistant (PDA), a mobile device, a tablet, or any other computing device.

A person having ordinary skill in the art will appreciate that the scope of the disclosure is not limited to realizing the summary creation server 104 and the user-computing device 106 as separate entities. In an embodiment, the summary creation server 104 may be realized as an application program installed on and/or running on the user-computing device 106 without departing from the scope of the disclosure.

In an embodiment, the communication network 108 may correspond to a communication medium through which the database server 102, the summary creation server 104, and the user-computing device 106 may communicate with each other. Such a communication may be performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 108 may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

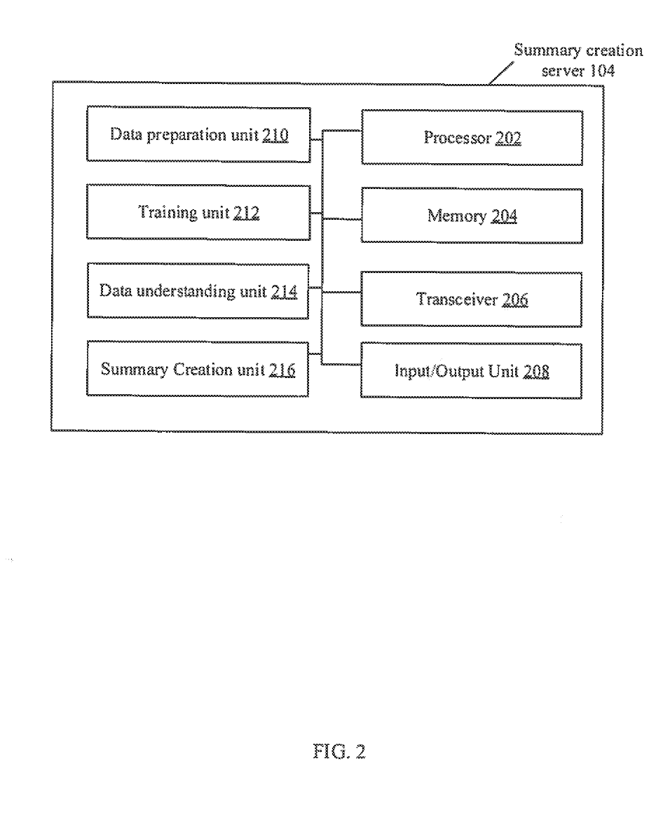

FIG. 2 is a block diagram that illustrates a summary creation server 104 configured to summarize a conversation, in accordance with some embodiments of the present disclosure. The summary creation server 104 may include a processor 202, a memory 204, a transceiver 206, and an input/output unit 208, a data preparation unit 210, a training unit 212, a data understanding unit 214, a summary creation unit 216. The processor 202 may be communicatively coupled to the memory 204, the transceiver 206, and the input/output unit 208, the data preparation unit 210, the training unit 212, the data understanding unit 214, and the summary creation unit 216.

The processor 202 may include suitable logic, circuitry, interfaces, and/or code that may be configured to execute a set of instructions stored in the memory 204. The processor 202 may be implemented based on a number of processor technologies known in the art. Examples of the processor 202 include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

The memory 204 may include suitable logic, circuitry, interfaces, and/or code that may be configured to store the set of instructions, which may be executed by the processor 202. In an embodiment, the memory 204 may be configured to store one or more programs, routines, or scripts that may be executed in coordination with the processor 202. The memory 204 may be implemented based on a Random Access Memory (RAM), a Read-Only Memory (ROM), a Hard Disk Drive (HDD), a storage server, and/or a Secure Digital (SD) card.

The transceiver 206 may include of suitable logic, circuitry, interfaces, and/or code that may be configured to receive a request for summarization of the conversation from the user-computing device 106. In an embodiment, the transceiver 206 may be configured to transmit the summary of the conversation to the user-computing device 106. In an embodiment, the transceiver 206 may be configured to transmit a request to the database server 102 to provide the domain dictionaries associated with the conversation. The transceiver 206 may implement one or more known technologies to support wired or wireless communication with the communication network. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)

The Input/ Output (I/O) unit 208 may include suitable logic, circuitry, interfaces, and/or code that may be configured to receive an input or transmit an output. The input/output unit 208 may include various input and output devices that are configured to communicate with the processor 202. Examples of the input devices include, but are not limited to, a keyboard, a mouse, a joystick, a touch screen, a microphone, and/or a docking station. Examples of the output devices include, but are not limited to, a display screen and/or a speaker.

The data preparation unit 210 may include suitable logic, circuitry, interfaces, and/or code that may be configured to split each of a plurality of sentences in the conversation into one or more phrases based on one or more pre-defined grammar rules. In an embodiment, the one or more phrases may be utilized to update a pre-defined knowledge base. The data preparation unit 210 may be further configured to remove dis-ambiguity within each of the plurality of sentences based on the one or more pre-defined grammar rules. The data preparation unit 210 may be further configured to identify one or more anaphors within each of the plurality of sentences. In an embodiment, each of the one or more anaphors may be replaced with corresponding one or more nouns. The data preparation unit 210 may be further configured to remove one or more non-American Standard Code for Information Interchange (ASCII) characters from each of the plurality of sentences.

The training unit 212 may include suitable logic, circuitry, interfaces, and/or code that may be configured to update the domain dictionaries based on the one or more relevant phrases. In an embodiment, the domain dictionaries may be built based on the user inputs from experts well versed in the subject matter of the domain of the conversation. In an embodiment, the training unit 212 may update the pre-defined knowledge base, based on information received from the data understanding unit 214.

The data understanding unit 214 may be configured to extract, one or more relevant phrases associated with each of the one or more phrases based on domain dictionaries and the pre-defined knowledge base. The data understanding unit 214 may be configured to correlate each of the one or more phrases and the one or more relevant phrases based on a relationship score. In an embodiment, the data understanding unit 214 may create a plurality of vectors based on the one or more phrases, the one or more relevant phrases, and the pre-defined knowledge base. In embodiment, the data understanding unit 214 may be configured to create, a relationship graph, comprising a plurality of nodes. In an embodiment, a vector similarity technique may be implemented on each of the plurality of vectors to create the relationship graph. In an embodiment, the data understanding unit 214 may identify at least one of a core topic of discussion in the conversation, one or more issues associated with the core topic of discussion, one or more resolved issues from the one or more issues, and one or more unresolved issues from the one or more issues based on the determined correlation. The data understanding unit 214 may determine a type of each of the plurality of sentences based on one or more pre-defined sentence parsing techniques. In an embodiment, the type of plurality of sentences may correspond to one of a question and an answer. The data understanding unit 214 may be configured to identify a question-answer pair based on the type of each of the plurality of sentences and one or more logical parsing rules.

The summary creation unit 216 may include suitable logic, circuitry, interfaces, and/or code that may be configured to create a summary of the conversation based on the core topic of discussion in the conversation, the one or more issues, the one or more resolved issues and the one or more unresolved issues.

In operation, the user-computing device 106 may be configured to transmit a request for summarizing a conversation to the summary creation server 104. The user-computing device 106 may transmit the conversation between a virtual agent and a user along with the request, to the summary creation server 104. The summary creation server 104 may be configured to receive the conversation between the virtual agent and the user. For example, below is a sample conversation received by the summary creation server 104 for summarization.

### Sample Conversation

User: Hi
Virtual Agent: Hi User
User: Printer is not working and I am unable to print anything, also (It displays cartridge empty.
Virtual Agent: Is the print not clear?
User: No, not printing at all.
Virtual Agent: Is the paper tray empty?
User: No. The paper tray has paper and it is not empty.
Virtual Agent: are the drivers for the printer installed?
User: I am not aware of it.
Virtual Agent: Can the printer be connected through devices?
User: Yes, the printer can be connected via phones or tablets by Bluetooth.

User: How long will it take to resolve the issue?
Virtual Agent: Wait a moment User, I shall escalate the matter to a manual agent.

After receiving the conversation, the data preparation unit 210 may remove dis-ambiguity within each of the plurality of sentences based on the one or more pre-defined grammar rules. Example: “User: Printer is not working. I am unable to print anything. (It displays no cartridge.” Virtual Agent: Is the print not clear?” In this example the reply by the Virtual Agent may not be in coherence with the conversation of the user. In the example, the reply by the virtual agent is an ambiguity. In an embodiment, the data preparation unit 210 may remove ambiguous sentences from the conversation for further processing.

After removing the dis-ambiguity the data preparation unit 210 may identify one or more anaphors within each of the plurality of sentences and one or more anaphors may be replaced with one or more corresponding nouns. Example: “Printer is not working. I am unable to print anything. It displays no cartridge.” In the example, the noun referred is the printer whereas, the corresponding pronoun is “It”. In an embodiment, the pronoun “It” is replaced with the noun, that is the “printer” and the sentence may appear as “Printer is not working.” “Printer displays no cartridge.”

In an embodiment, the data preparation unit 210 may be configured to remove one or more non-ASCII (American Standard Code for Information Interchange) characters from each of the plurality of sentences. Example: non-ASCII characters may involve, £, (,). In the sample conversation shown above, “(It displays cartridge empty.” the user has mentioned a reply in certain non-ASCII characters, such as “(”. In an embodiment, the data preparation unit 210 may be configured to remove the non-ASCII characters, such as “(”, as shown in the example. The resultant sentence may look like, “It displays cartridge empty.”, without the use of non-ASCII characters.

In an embodiment, the plurality of sentences in the conversation may be split into one or more phrases based on one or more pre-defined grammar rules. The one or more phrases may be utilized to update the pre-defined knowledge base. Example: “Printer is not working and I am unable to print anything, also It displays cartridge empty.” In the example, the sentence has been extracted from the conversation. The sentence is a single sentence containing several state of actions. The state of actions are verbs, which may be pre-defined in the grammar rules. The sentence may be split into one or more phrases having a verb and its corresponding noun, which qualifies the noun itself. For example, conjunctions like “and” and punctuations, preferable commas may be deleted from the sentences, that may enable sentence separation. The resultant sentence may look like, “Printer is not working.”, “I am unable to print anything”, “Printer displays empty cartridge.” For example, the one or more phrases obtained after splitting the plurality of sentence may include printer, not working, unable to print, and empty cartridge.

In an embodiment, the data preparation unit 210 may be configured to determine a domain dictionary associated with the conversation based on the one or more phrases. For example, the domain for the above shown sample conversation is IT infrastructure domain dictionary. After determining the domain dictionary of the conversation, the transceiver 206 may be configured to request the determined domain dictionary to the database server 102.

In an embodiment, the domain dictionaries may be built based on inputs from users' expert in a subject matter. In an embodiment, the domain dictionaries may include one or more relevant phrases that may be associated with a domain of the one or more phrases. The users may be experts in subject matters in information technology (IT)domain. For example, hardware engineer, IT security expert. The user may create the domain dictionaries and store it in the database server 102. For example, a IT infrastructure domain dictionary may include one or more relevant phrases, such as desktop, laptop, router, printer, and the like. For example, a IT security domain dictionary ay include one or more relevant phrases, such as token, password, username, and the like.

In an embodiment, the pre-defined knowledge base may be built based on inputs from users' expert in a subject matter. The knowledge base may include the one or more phrases, that indicate at least one of: an issue, a resolution of the issue, or one or more action items associated with the issue. For example, in the sample conversation given above, the issue may be “printer not working due to cartridge empty”, the resolution of the issue may be “replace printer cartridge” and the one or more action items associated with the issue may include assigning the issue to a manual agent for resolving the issue. In an embodiment, the domain dictionaries and the pre-defined knowledge base may be stored in the database server 102.

In an embodiment, the one or more pre-defined grammar rules may be learnt by the training unit 212 of the summary creation server 104 in a semi-supervised manner. In an embodiment, new information may be required to build the knowledge base. Such new information may be received from the data understanding unit 214. In an embodiment, different parts of each of the plurality of sentences may be analyzed for a frequency of occurrences while subjecting to an extraction rule. Based on the new parts failing the one or more pre-defined grammar rules, new rules may be added to the one or more pre-defined grammar rules and may be reviewed by an expert.

In response to the request for transmission of the determined domain dictionary to the database server 102, the database server 102 may transmit the determined domain dictionary to the summary creation server 104. For example, the database server 102 may transmit the IT infrastructure domain dictionary to the summary creation server 104.

The data understanding unit 214 may extract one or more relevant phrases associated with each of the one or more phrases based on the received domain dictionaries (IT infrastructure domain dictionary) and the knowledge base. For example, based on the received IT infrastructure domain dictionary, the one or more relevant phrases associated with each of the one or more phrases may extracted as shown in the below Table 1.

TABLE 1

| One or more phrases | One or more relevant phrases |
|---|---|
| Printer | Photocopier, laser printer, inkjet |
| | printer, printing machine |
| Not working | Failure, malfunction, breakdown, error, |
| | fault |
| Cartridge | Toner, color palette |
| Bluetooth | Wireless, infrared, network, LAN, |
| | WIFI |
| Printing is too slow | Printer performance |
| Wireless devices | Mobile, tablet |

In an embodiment, the issue may be related to a malfunctioning printer. Phrases only relevant to the issue may be extracted from the knowledge base. In an embodiment, a resolution of the identified issue may be retrieved from the knowledge base. Thus, the extracted one or more relevant phrases may include phrases extracted from the knowledge base and the domain dictionaries.

In an embodiment, the training unit 212 may update the pre-defined knowledge base, based on information received from the data understanding unit 214. In an embodiment, the training unit 212 may update the pre-defined knowledge base and the domain dictionaries to include the one or more phrases. For example, the training unit 212 may update the pre-defined knowledge base to include action items for resolving the identified issue of printer not working and the training unit 212 may update the domain dictionaries to include one or more phrases, such as printer, not working, cartridge, and the like.

After extraction of the one or more relevant phrases, the data understanding unit 214 may be configured to assign a relative importance score to each of the one or more phrases and the one or more relevant phrases based on the number of occurrence of each of the phrases in the conversation. The data understanding unit 214 may be configured to determine a correlation between each of the one or more phrases and the one or more relevant phrases based on a relationship score. In order to determine the relationship score, the data understanding unit 214 may be configured to create a plurality of vectors based on the one or more phrases, the one or more relevant phrases. In an embodiment, the plurality of vectors may include sentence vector, phrase vector, issue vector and resolution vector.

In an embodiment, each of the one or more phrases may be represented by a vector. For example, in the sentence “Printer in not working”, the extracted phrases are “Printer” and “Not working”. In an embodiment, the plurality of vectors may be a combination of the vectors of the individual phrases in the sentences. For example, “Printer” has vector (0.5, 0.75, 0.87), “Not working has vector” (0.49, 0.2, 0.5). So “Printer in not working” may be represented as (0.5, 0.75, 0.87) (0.49, 0.2, 0.5)

After creation of the vectors, the data understanding unit 214 may be configured to determine the relationship score between the one or more phrases and the one or more relevant phrases in the plurality of vectors. In an embodiment, the relationship score may be determined by implementing a vector similarity technique on each of the plurality of vectors. For example: the one or more phrases may be a printer, whereas the one or more relevant phrases may be a photocopier, laser printer, inkjet printer or printing machine. In an embodiment, the vector for printer may be (0.5, 0.75, 0.87), whereas the vector for photocopier may be (0.5, 0.69, 0.87). The relative importance score for printer and photocopier in the instant case is 0.2. Similarly, the relative importance score for “not working”, “failure” and “malfunctioning” may be 0.15. Table 2 shown below is an illustrative example of the relative importance score assigned to each of the one or more phrases and the one or more relevant phrases.

TABLE 2

| | | Relative |
|---|---|---|
| Phrase/Relevant | | importance |
| phrase | Vector | score |
| Printer | (0.5, 0.75, .87), | .2 |
| photocopier | (0.5, 0.69, .87) | .2 |
| Not working | (.49, .2, .5) | .15 |
| failure | (.49, .1, .5) | .15 |
| Malfunctioning | (.49, .2, .3) | .15 |
| Cartridge | (.47, .15, .3) | .01 |
| Toner | (.47, .10, .3) | .01 |
| LAN Cable | (.45, .10, .2) | .025 |
| Network cable | (.45, .12 .4) | .025 |
| Driver | (.42, .10, .3) | .024 |
| software | (.42, .15, .3) | .024 |

In an embodiment, the relationship score determined between “printer” and “photocopier” by implementing a vector similarity technique may be 0.998. Similarly, the relationship score determined between “not working”, “failure”, “malfunctioning” by implementing a vector similarity technique may be 0.997. The relationship score between “cartridge” and “toner” may be 0.996 and for “LAN cable”, “network cable” and “driver” and “software” may be 0.995 and 0.994, respectively.

After determining the relationship score between the one or more phrases and the one or more relevant phrase, the data understanding unit 214 may be configured to create a relationship graph, comprising a plurality of nodes, based on the vector similarity technique implemented on the plurality of vectors. In an embodiment, the relationship graph may further comprise the relationship score assigned between each of two nodes from the plurality of nodes. The plurality of nodes may comprise a parent node corresponding to the core topic of discussion in the conversation, and a plurality of sub nodes corresponding to one or more phrases and the one or more relevant phrases. In an embodiment, a parent node may correspond to printer, which is the core topic. The sub-nodes may correspond to at least one or more ink, cartridge, paper, driver and further sub-nodes may comprise of one or more phrases like, “print not clear”, “paper tray empty”, “paper stuck” and “check the drivers”.

In an embodiment, the relationship graph may be created based on the plurality of vectors and the relationship score. The relationship graph may include the parent node and its subsequent nodes. The parent node may be configured to contain phrases and subsequent nodes initially originating from the parent node may be configured to contain the relevant phrases corresponding to the parent node. The parent node and the subsequent nodes may be connected by vector similarity technique. For example, the parent node may be printer with vector (0.5, 0.75, 0.87) and the vector for the subsequent node, photocopier may be (0.5, 0.69, 0.87). The relationship score between the parent node and the subsequent node may be 0.998. The relationship score connects the plurality of nodes and may be utilized to create the relationship graph by connecting the one or more nodes.

After creation of the relationship graph, the data understanding unit 214 may be configured to identify at least one of a core topic of discussion in the conversation, one or more issues associated with the core topic of discussion, one or more resolved issues from the one or more issues, and one or more unresolved issues from the one or more issues based on the relationship graph. In an embodiment, the data understanding unit 214 may be configured to determine an assent obtained from the user based on the response of the user. In order to determine the one or more resolved issues and the one or more unresolved issues, the data understanding unit 214 may be configured to determine a type of each of the plurality of sentences based on one or more pre-defined sentence parsing techniques. In an embodiment, the type may correspond to one of a question and an answer. For example, in the sample conversation the data understanding unit 214 may be configured to determine that a question (Is the paper tray empty?) was asked by the user and the sentence ended with a question mark. Such a sentence may be identified as a question. In an embodiment, such a question may be identified as an issue.

In an embodiment, after identifying the type (question) of the plurality of sentences, the data understanding unit 214 may be configured to determine whether the sentence after the identified question is an answer. For example, in the sample conversation: “Virtual Agent: Is the paper tray empty? User: No. The paper tray has paper and it is not empty.”, the user response provided by the user is in coherence with the question asked by the virtual agent. Thus, the data understanding unit 214 may be configured to determine that the response is an answer to the identified question. Further, data understanding unit 214 may be configured to determine that the issue identified in the question is a resolved issue based on the answer received from the user.

Similarly, there may be examples of one or more unresolved issues in the conversation. For example, in the sample conversation “Virtual Agent: are the drivers for the printer installed? User: I am not aware of it.”, the issue is whether the printer drivers are installed or not and the response provided by the user is “I am not aware of it.” Thus, the data understanding unit 214 may be configured to determine that the issue of “printer drivers installation” is an unresolved issue. In an embodiment, the data understanding unit 214 may be configured to identify a question answer pair based on the core topic of discussion.

After identifying the core topic, the one or more resolved issues and the one or more unresolved issues, the summary creation unit 216 may be configured to create a summary of the conversation based on the core topic identified in the conversation, the one or more issues, the one or more resolved issues, and the one or more unresolved issues. For example, the summary of the sample conversation may be as shown in the table 3 below.

TABLE 3

| Core | | | Unresolved |
|---|---|---|---|
| topic | Issues | Resolved issues | issues |
| Printer | Not working, | — | Not printing |
| | unable to print | | |
| | Cartridge empty | — | — |
| | Drivers for printer | — | Drivers for |
| | installed | | printer not |
| | | | installed |
| | Paper tray empty | Paper tray not | — |
| | | empty | |
| | How long to | — | Time duration |
| | resolve | | to resolve not |
| | | | known. Issue |
| | | | escalated |
| | Printer be | Printer can be | — |
| | connected | connected via | |
| | through devices | phones or tablets | |
| | | by Bluetooth | |

After creation of the summary, the summary may be transmitted to the user-computing device 106. In an embodiment, the summary may be displayed on the display screen of the user-computing device 106. In an embodiment, the summary may be provided to the manual agent to which the end user has been connected for resolving the unresolved issues.

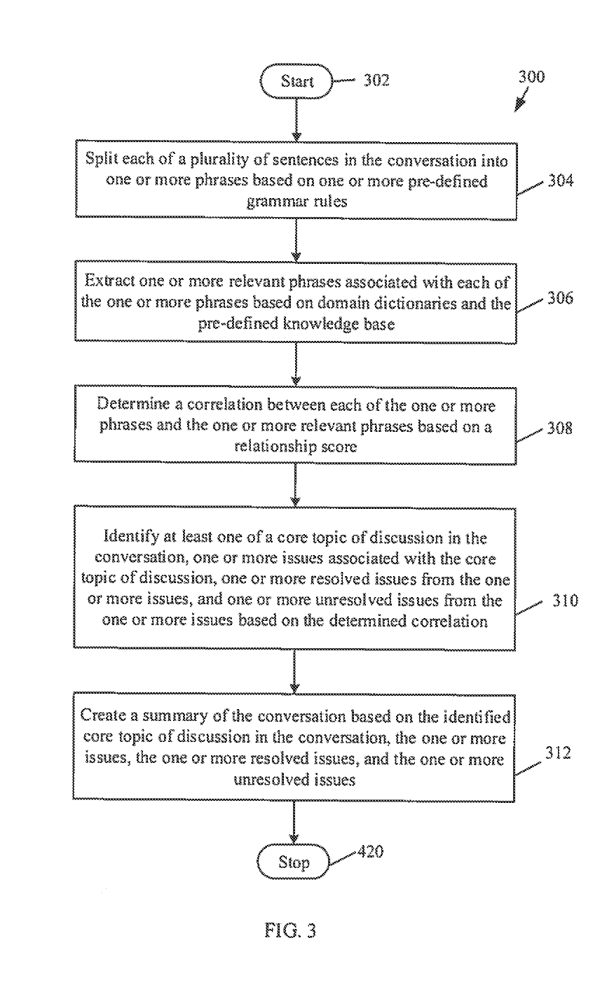

FIG. 3 is a flowchart illustrating a method 300 for summarizing a conversation, in accordance with some embodiments of the present disclosure. The method starts at step 302 and proceeds to step 304.

At step 304, the summary creation server 104 may split each of a plurality of sentences in the conversation into one or more phrases based on one or more pre-defined grammar rules. At step 306, the summary creation server 104 may be configured to extract one or more relevant phrases associated with each of the one or more phrases based on domain dictionaries and the pre-defined knowledge base. At step 308, the summary creation server 104 may be configured to determine a correlation between each of the one or more phrases and the one or more relevant phrases based on a relationship score. At step 310, the summary creation server 104 may be configured to identify at least one of a core topic of discussion in the conversation, one or more issues associated with the core topic of discussion, one or more resolved issues from the one or more issues, and one or more unresolved issues from the one or more issues based on the determined correlation. At step 312, the summary creation server 104 may be configured to create a summary of the conversation based on the identified core topic of discussion in the conversation, the one or more issues, the one or more resolved issues, and the one or more unresolved issues. Control passes to end step 314.

### Computer System

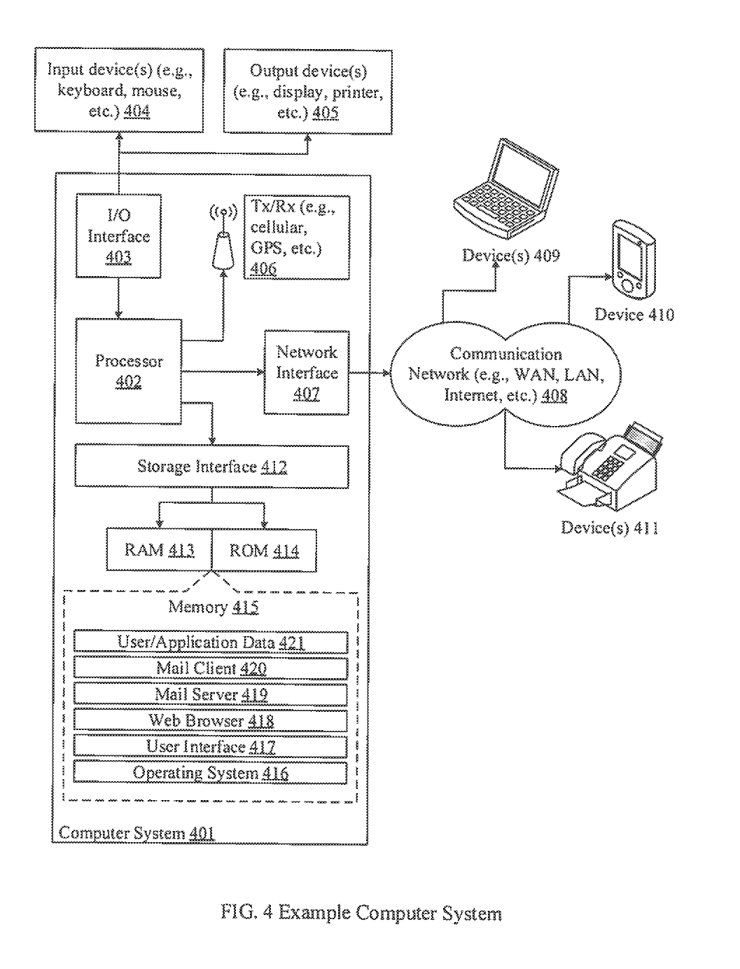

FIG. 4 illustrates a block diagram of an exemplary computer system for implementing embodiments consistent with the present disclosure. Variations of computer system 401 may be used for performing optical character recognition on an image including a plurality of printed characters. The computer system 401 may comprise a central processing unit (“CPU” or “processor”) 402. Processor 402 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM' s application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 410, 411, and 412. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObj ects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method of summarizing a conversation, the method comprising:
splitting, by a summary creation server, each of a plurality of sentences in the conversation into one or more phrases based on one or more pre-defined grammar rules, wherein the one or more phrases are utilized to update a pre-defined knowledge base;
extracting, by the summary creation server, one or more relevant phrases associated with each of the one or more phrases based on domain dictionaries and the pre-defined knowledge base;
determining, by the summary creation server, a correlation between each of the one or more phrases and the one or more relevant phrases based on a relationship score;
identifying, by the summary creation server, at least one of a core topic of discussion in the conversation, one or more issues associated with the core topic of discussion, one or more resolved issues from the one or more issues, and one or more unresolved issues from the one or more issues based on the determined correlation; and
creating, by the summary creation server, a summary of the conversation based on the identified core topic of discussion in the conversation, the one or more issues, the one or more resolved issues, and the one or more unresolved issues.

2. The method of claim 1, further comprising removing dis-ambiguity within each of the plurality of sentences based on the one or more pre-defined grammar rules.

3. The method of claim 1, further comprising identifying one or more anaphors within each of the plurality of sentences, wherein each of the one or more anaphors are replaced with corresponding one or more nouns.

4. The method of claim 1, further comprising removing one or more non-American Standard Code for Information Interchange (ASCII) characters from each of the plurality of sentences.

5. The method of claim 1, wherein the pre-defined knowledge base comprises the one or more phrases, that indicate at least one of: an issue, a resolution of the issue, or one or more action items associated with the issue.

6. The method of claim 1, wherein the one or more relevant phrases are associated with a domain of the one or more phrases.

7. The method of claim 1, wherein identifying the core topic of discussion in the conversation further comprises:
determining a type of each of the plurality of sentences based on one or more pre-defined sentence parsing techniques, wherein the type corresponds to one of a question and an answer,
identifying a question-answer pair based on the type of each of the plurality of sentences and one or more logical parsing rules.

8. A summary creation server comprising:
a processor; and
a memory communicatively coupled to the processor, wherein the memory stores processor instructions, which, on execution, causes the processor to:
split each of a plurality of sentences in the conversation into one or more phrases based on one or more pre-defined grammar rules, wherein the one or more phrases are utilized to update a pre-defined knowledge base;
extract one or more relevant phrases associated with each of the one or more phrases based on domain dictionaries and the pre-defined knowledge base;
determine a correlation between each of the one or more phrases and the one or more relevant phrases based on a relationship score;
identify at least one of a core topic of discussion in the conversation, one or more issues associated with the core topic of discussion, one or more resolved issues from the one or more issues, and one or more unresolved issues from the one or more issues based on the determined correlation; and
create a summary of the conversation based on the identified core topic of discussion in the conversation, the one or more issues, the one or more resolved issues, and the one or more unresolved issues.

9. The summary creation server of claim 8, wherein the processor is further configured to remove dis-ambiguity within each of the plurality of sentences based on the one or more pre-defined grammar rules.

10. The summary creation server of claim 8, wherein the processor is further configured to identify one or more anaphors within each of the plurality of sentences, wherein each of the one or more anaphors are replaced with corresponding one or more nouns.

11. The summary creation server of claim 8, wherein the processor is further configured to remove one or more non-American Standard Code for Information Interchange (ASCII) characters from each of the plurality of sentences.

12. The summary creation server of claim 8, wherein the pre-defined knowledge base comprises the one or more phrases, that indicate at least one of an issue, a resolution of the issue, or one or more action items associated with the issue.

13. The summary creation server of claim 8, wherein the one or more relevant phrases are associated with a domain of the one or more phrases.

14. The summary creation server of claim 8, wherein identifying the core topic of discussion in the conversation further comprises:
determining a type of each of the plurality of sentences based on one or more pre-defined sentence parsing techniques, wherein the type corresponds to one of a question and an answer,
identifying a question-answer pair based on the type of each of the plurality of sentences and one or more logical parsing rules.

15. A non-transitory computer-readable storage medium having stored thereon, a set of computer-executable instructions for causing a computer comprising one or more processors to perform steps comprising:
splitting each of a plurality of sentences in a conversation into one or more phrases based on one or more pre-defined grammar rules, wherein the one or more key phrases are utilized to build a pre-defined knowledge base;
extracting one or more relevant phrases associated with each of the one or more phrases based on domain dictionaries and the pre-defined knowledge base;
determining a correlation between each of the one or more phrases and the one or more relevant phrases based on a relationship score;
identifying at least one of a core topic of discussion in the conversation, one or more issues associated with the core topic of discussion, one or more resolved issues from the one or more issues, and one or more unresolved issues from the one or more issues based on the determined correlation; and
creating a summary of the conversation based on the identified core topic of discussion in the conversation, the one or more issues, the one or more resolved issues, and the one or more unresolved issues.
